(19) United States
(12) Patent Application Publication
(10) Pub. No.: US 2014/0279564 A1
(43) Pub. Date: Sep. 18, 2014

(54) ANONYMOUS TEXT AND PAYMENT SYSTEM

(71) Applicant: MeetMePay, Inc., Austin, TX (US)

(72) Inventors: Jesse Benjamin Dyer, Atlanta, GA (US); Ben John Dyer, Austin, TX (US); Stephen Douglas Crawford, Decatur, GA (US)

(73) Assignee: MeetMePay, Inc., Austin, TX (US)

(21) Appl. No.: 14/200,368

(22) Filed: Mar. 7, 2014

Related U.S. Application Data
(60) Provisional application No. 61/788,505, filed on Mar. 15, 2013.

(51) Int. Cl. G06Q 20/32; G06Q 20/38; G06Q 20/40

(52) U.S. Cl. CPC G06Q 20/3255; G06Q 20/4014; G06Q 20/383
USPC 705/72

(57) ABSTRACT

Methods, systems, apparatus, and computer program products are provided for facilitating anonymous texts and payments between a buyer and a seller. In one embodiment, a method is provided comprising (a) receiving input indicating a user selection of an item associated with a seller and a price that a user is interested in buying; (b) receiving a first text message from the user comprising a buy command; (c) providing a prompt to the user to provide a passcode via a second text message; (d) receiving a third text message from the user comprising a passcode; and (e) facilitating payment by the user to the seller of an amount based at least in part on the price associated with the item.

### RELATED APPLICATIONS

This application claims priority to U.S. Provisional Application Ser. No. 61/788,505, filed Mar. 15, 2013, which is hereby incorporated herein in its entirety.

### BACKGROUND

1. Field of Invention

The present invention is generally related to mobile communications and payments.

2. Description of Related Art

It can be difficult for a buyer and a seller of an item to connect anonymously, schedule a meet up, physically exchange the item, and/or pay without cash. Also, bandwidth is usually severely limited at or near venues for popular events, such as concerts, college football games, etc. due to the large number of people attempting to access bandwidth in the vicinity of the venue. Thus, there exists in the art a need for methods, systems, apparatus, and computer program products that facilitate anonymous exchanges and payments while using minimal bandwidth.

### BRIEF SUMMARY

This document describes a method for allowing buyers (using any major credit card, a checking account, or other payment option) and sellers (using a checking account or other payment receipt option) in an online marketplace to communicate and pay each other anonymously via mobile messaging (e.g., short message service (SMS) messages, text messages, multimedia message service (MMS) messages, extended messaging service (EMS) messages, and/or the like), which is particularly useful when internet bandwidth is limited or unavailable.

In various embodiments, the anonymous text and payment system may provide a marketplace system that allows registered users to buy and sell tickets (e.g., concert tickets and/or the like) or other items to each other. In various embodiments, anonymous users may browse the inventory of tickets or other items but are not able to buy or sell tickets or items until after they sign up and provide the appropriate information. Signing up (i.e., registering), listing tickets or other items for sale, browsing ticket or item inventory, and reserving tickets or other items may all occur through a web interface. In various embodiments, once a buyer reserves tickets or other items, the text and payment process begins to complete the transaction via mobile messaging between the buyer, seller, and the anonymous text and payment system.

Various embodiments of present invention provide systems, methods, apparatus, and computer-program products containing executable code for facilitating anonymous communication and transaction completion. In various embodiments, the systems include a wireless computing device. The wireless computing device may be one of several types of devices such as smartphone devices, mobile telephones, mobile computers, portable digital assistants (PDAs), laptop computers, gaming devices, electronic tablets, or other types of similar electronic devices. In addition, in various embodiments, the wireless computing device may include imaging capabilities.

According to one aspect of the present invention, a method for facilitating anonymous texts and payments between a user and a seller is provided. The method includes (a) receiving input indicating a user selection of an item associated with a seller and a price that a user is interested in buying; (b) receiving a first text message from the user comprising a buy command; (c) providing a prompt to the user to provide a passcode via a second text message; (d) receiving a third text message from the user comprising a passcode; and (e) facilitating payment by the user to the seller of an amount based at least in part on the price associated with the item.

In various embodiments, the method may also include receiving a fourth text message from the user comprising a message for the seller; and providing the message to the seller via a fifth text message that does not include a phone number directly associated with the user. In various embodiments, the method may also include receiving a sixth text message from the seller comprising a message for the user; and providing the message to the user via a seventh text message that does not include a phone number directly associated with the seller. In some embodiments, the method may include determining if the user has the appropriate credentials to buy the item after receiving input indicating the user selection of the item and before providing a prompt to the user to provide the passcode. If it is determined that the user does not have the appropriate credentials to buy the item, a prompt may be provided to the user to provide payment mechanism information. The payment mechanism information may comprise at least one of a credit card number, a bank account number and routing number, a debit card number, or a gift card number. In various embodiments, the method further comprises providing a payment confirmation to at least one of the user and the seller via an additional text message.

In another aspect, a system for facilitating anonymous texts and payments between a user and a seller is provided. The system includes one or more memory storage areas containing information associated with at least one item for sale, the information comprising a seller and a price, and profile data associated with at least one of a seller and a user. The system also includes one or more processors configured to (a) receive an indication of a user selection of an item that a user is interested in buying; (b) receive a first text message from the user comprising a buy command; (c) provide a prompt to the user to provide a passcode via a second text message; (d) receive a third text message from the user comprising a passcode; and (e) facilitate payment by the user to the seller of an amount based at least in part on the price associated with the item.

In various embodiments, the one or more processors may be configured to receive a fourth text message from the user comprising a message for the seller; and provide the message to the seller via a fifth text message that does not include a phone number directly associated with the user. In various embodiments, the one or more processors may be configured to receive a sixth text message from the seller comprising a message for the user; and provide the message to the user via a seventh text message that does not include a phone number directly associated with the seller. In some embodiments, the one or more processors are configured to determine if the user has the appropriate credentials to buy the item, after receiving the indication of the user selection of the item and before providing a prompt to the user to provide the passcode. In various embodiments, the one or more processors may be further configured to, if it is determined that the user does not have the appropriate credentials to buy the item, provide a prompt to the user to provide payment mechanism information. The payment mechanism information may comprise at least one of a credit card number, a bank account number and routing number, a debit card number, or a gift card number. In various embodiments, the one or more processors are further configured to provide a payment confirmation to at least one of the user and the seller via another text message.

In yet another aspect of the present invention, a computer program product for facilitating anonymous texts and payments between a user and a seller is provided. The computer program product comprises at least one non-transitory computer-readable storage medium having computer-readable program code portions embodied therein. The computer-readable program code portions include an executable portion configured for receiving a plurality of data, the plurality of data comprising information associated with at least one item for sale, the information comprising a seller and a price, and profile data associated with at least one of a seller and a user. The computer-readable program code portions further include an executable portion configured for receiving an indication of a user selection of an item that a user is interested in buying; an executable portion configured for receiving a first text message from the user comprising a buy command; an executable portion configured for providing a prompt to the user to provide a passcode via a second text message; an executable portion configured for receiving a third text message from the user comprising a passcode; and an executable portion configured for facilitating payment by the user to the seller of an amount based at least in part on the price associated with the item.

In various embodiments, the computer program product may also include an executable portion configured for receiving a fourth text message from the user comprising a message for the seller; and an executable portion configured for providing the message to the seller via a fifth text message that does not include a phone number directly associated with the user. In various embodiments, the computer program product may also include an executable portion configured for receiving a sixth text message from the seller comprising a message for the user; and an executable portion configured for providing the message to the user via a seventh text message that does not include a phone number directly associated with the seller. In some embodiments, the computer program product includes an executable portion configured for, after receiving the indication of the user selection of the item and before providing a prompt to the user to provide the passcode, determining if the user has the appropriate credentials to buy the item. In various embodiments, the computer program product also includes an executable portion configured for, if it is determined that the user does not have the appropriate credentials to buy the item, providing a prompt to the user to provide payment mechanism information. In various embodiments, the computer program product includes an executable portion configured for providing a payment confirmation to at least one of the user and the seller via another text message.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides an illustration of one embodiment of an architecture that can be used to practice various aspects of the present invention.

FIG. 2 provides a schematic diagram of a wireless computing device according to one embodiment of the present invention.

FIG. 3 provides a schematic diagram of a server residing in a common carrier's systems according to one embodiment of the present invention.

FIG. 4 shows an example context in which the present invention may be used. The user may communicate with the Marketplace Website and also with the Anonymous Phone Number from the Mobile Messaging Provider. The Marketplace Website may communicate with the Payment Processor to establish buyer and seller credentials and to process payments. The Marketplace Website may also communicate with the Mobile Messaging Provider to assign an Anonymous Phone Number from a pool of available phone numbers and to send, receive, and process text messages.

FIG. 5 shows the User Registration process, according to various embodiments of the present invention.

FIG. 6 shows the Browse/Search process, according to various embodiments of the present invention. As the user browses and searches the Marketplace Website, he may want to buy or sell an item. Selecting buy starts the Text & Payment Session as shown in FIG. 7.

FIG. 7 shows the Text & Payment Session process, according to various embodiments of the present invention. An order may be created for the item for sale, and a session is opened between the buyer and seller to allow them to communicate via text messages. The session may be closed when the buyer completes the order and payment is processed, when buyer cancels the order, or when the seller deletes the item for sale.

FIG. 8 shows the Process Text Messages process, according to various embodiments of the present invention. Text messages from users (buyer and seller) may be passed thru to the other user in the session unless the text message is a known command or the user's PIN. If the text message is the Buy Command, then the user may be prompted with a text message to enter his PIN. If the responding text message includes the user's PIN, then the order may be processed—i.e., the buyer is debited, the seller is credited, and the marketplace is credited.

### DETAILED DESCRIPTION

The present invention now will be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### I. METHODS, APPARATUS, SYSTEMS, AND COMPUTER PROGRAM PRODUCTS

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Particular embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. EXEMPLARY SYSTEM ARCHITECTURE

FIG. 1 provides an illustration of a system architecture that can be used in conjunction with various embodiments of the present invention. As shown in FIG. 1, the system architecture may include one or more wireless computing devices 101. For instance, the wireless computing devices 101 may be smartphone devices, mobile telephones, mobile computers, portable digital assistants (PDAs), laptop computers, gaming devices, electronic tablets, and other types of similar electronic devices. In addition, in various embodiments, the wireless computing devices 101 may include digital imaging capabilities.

Further, in various embodiments, the one or more wireless computing devices 101 are in communication with one or more additional systems. For instance, in particular embodiments, one or more of the wireless computing devices 101 are in cellular communication with one or more mobile messaging and/or cellular service providers 102. As discussed in greater detail below, these wireless computing devices 101 may transmit and receive data over cellular communication channels to facilitate anonymous communication and completion of transactions between users. In addition, these cellular service providers 102 may be in electronic communication with one or more marketplace systems 105 associated with an interactive marketplace to facilitate the transfer of information between the wireless computing devices 101. Such communication may be facilitated over the same or different wireless or wired networks including, for example, a wired or wireless Personal Area Network (PAN), Local Area Network (LAN), Metropolitan Area Network (MAN), Wide Area Network (WAN), cellular network, or the like. In addition, in particular embodiments, one or more of the wireless computing devices 101 may be in communication (directly or indirectly) with the marketplace system 105 over a wireless network.

In various embodiments, the one or more marketplace systems 105 may include sub-systems and/or components such as servers and storage media. For instance, in FIG. 1, the marketplace systems 105 include one or more registration modules 106 for registering users, one or more browse/search modules 107 for allowing users to browse and/or search item listings, post item listings, and/or edit item listings, and one or more text and payment modules 108 for facilitating anonymous texting and transaction completion. In addition, in particular embodiments, the carrier systems 105 include one or more servers 104. In particular instances, these one or more servers 104 may be in communication with one or more types of storage media 107. In addition, the one or more servers 104 may include a database management system and the storage media 107 may include one or more databases and one or more database instances. In various embodiments, the storage media 107 may be one or more types of media such as hard disks, magnetic tapes, optical media, or flash memory. The term “database” refers to a structured collection of records or data that is stored in a computer system, such as via a relational database, hierarchical database, or network database.

In various embodiments, the one or more marketplace systems 105 may also be in communication (directly or indirectly) with one or more payment processors 109 via a wired or wireless network. The payment processor 109 may comprise appropriate hardware and software for completing payment processing functions in accordance with various embodiments.

It should be noted that other system architectures are contemplated that may be used to practice various aspects of the invention. Thus, the system architecture provided in FIG. 1 is for illustrative purposes only and should not be construed to limit the scope of the invention. Further, while FIG. 1 illustrates certain system entities as separate, standalone entities, the various embodiments are not limited to this particular architecture.

a. Exemplary Wireless Computing Device

FIG. 2 provides a schematic diagram of a wireless computing device 101 according to one embodiment of the present invention. In this particular instance, the wireless computing device 101 is a smartphone. However, it should be understood that the wireless computing device 101 illustrated and hereinafter described is merely illustrative of one type of device that may implement and/or benefit from various embodiments and, therefore, should not be taken to limit the scope of the invention. Thus, it should be noted that other types of electronic devices, such as mobile telephones, mobile computers, portable digital assistants (PDAs), laptop computers, gaming devices, electronic tablets, and other types of similar electronic devices, may employ various embodiments of the invention.

As shown, the wireless computing device 101 may include an antenna 212 (or multiple antennas 212) in communication with a transmitter 214 and a receiver 216. The wireless computing device 101 may also include a processor 220 (e.g., application processor and/or graphics processor) configured to provide signals to and receive signals from the transmitter 214 and receiver 216, respectively.

The processor 220 may, for example, be embodied as various configurations including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 220 comprises a plurality of processors.

The signals sent and received by the processor 220 may include signaling information in accordance with an air interface standard of an applicable cellular system, and/or any number of different wireless networking techniques, comprising but not limited to Wi-Fi, wireless local access network (WLAN) techniques such as Bluetooth™ (BT), Ultra-wideband (UWB), Institute of Electrical and Electronics Engineers (IEEE) 802.11, 802.16, and/or the like. In addition, these signals may include speech data, user generated data, user requested data, and/or the like.

In this regard, the wireless computing device 101 may be capable of operating with one or more air interface standards, communication protocols, modulation types, access types, and/or the like. More particularly, the wireless computing device 101 may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the wireless computing device 101 may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the wireless computing device 101 may be capable of operating in accordance with 2.5G wireless communication protocols General Packet Radio Service (GPRS), Enhanced Data GSM Environment (EDGE), and/or the like. Further, for example, the wireless computing device 101 may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The wireless computing device 101 may be additionally capable of operating in accordance with 3.9G wireless communication protocols such as Long Term Evolution (LTE) or Evolved Universal Terrestrial Radio Access Network (E-UTRAN) and/or the like. Additionally, for example, the wireless computing device 101 may be capable of operating in accordance with fourth-generation (4G) wireless communication protocols such as LTE Advanced and/or the like as well as similar wireless communication protocols that may be developed in the future.

Some Narrow-band Advanced Mobile Phone System (NAMPS), as well as Total Access Communication System (TACS), wireless computing devices 101 may also benefit from embodiments of this invention, as should dual or higher mode phones (for example, digital/analog or TDMA/CDMA/analog phones). Additionally, the wireless computing device 101 may be capable of operating according to Wi-Fi or Worldwide Interoperability for Microwave Access (WiMAX) protocols.

It is understood that the processor 220 may comprise circuitry for implementing audio/video and logic functions of the wireless computing device 101. For example, the processor 220 may comprise a digital signal processor device, a microprocessor device, an analog-to-digital converter, a digital-to-analog converter, and/or the like. Control and signal processing functions of the wireless computing device 101 may be allocated between these devices according to their respective capabilities. Additionally, the processor 220 may comprise an internal voice coder (VC) 220a, an internal data modem (DM) 220b, and/or the like. Further, the processor 220 may comprise functionality to operate one or more software programs, which may be stored in memory. For example, the processor 220 may be capable of operating a connectivity program, such as a web browser. The connectivity program may allow the wireless computing device 101 to transmit and receive web content, such as location-based content, according to a protocol, such as Wireless Application Protocol (WAP), hypertext transfer protocol (HTTP), and/or the like. The wireless computing device 101 may be capable of using a Transmission Control Protocol/Internet Protocol (TCP/IP) to transmit and receive web content across the internet or other networks.

The wireless computing device 101 may also comprise a user interface including, for example, an earphone or speaker 224, a ringer 222, a microphone 226, a display 228, a user input interface, and/or the like, which may be operationally coupled to the processor 220. In this regard, the processor 220 may comprise user interface circuitry configured to control at least some functions of one or more elements of the user interface, such as, for example, the speaker 224, the ringer 222, the microphone 226, the display 228, and/or the like. The processor 220 and/or user interface circuitry comprising the processor 220 may be configured to control one or more functions of one or more elements of the user interface through computer program instructions (for example, software and/or firmware) stored on memory accessible to the processor 220 (for example, volatile memory 240, non-volatile memory 242, and/or the like). Although not shown, the wireless computing device 101 may comprise a battery for powering various circuits related to the wireless computing device 101, for example, a circuit to provide mechanical vibration as a detectable output. The user input interface may comprise devices allowing the wireless computing device 101 to receive data, such as a keypad 230, a touch display (not shown), a joystick (not shown), and/or other input device. In embodiments including a keypad, the keypad may comprise numeric (0-9) and related keys (#, *), and/or other keys for operating the wireless computing device 101.

As shown in FIG. 2, the wireless computing device 101 may also include one or more components for sharing and/or obtaining data. For example, the wireless computing device 101 may comprise a short-range radio frequency (RF) transceiver and/or interrogator 264 so data may be shared with and/or obtained from electronic devices in accordance with RF techniques. The wireless computing device 101 may comprise other short-range transceivers, such as, for example, an infrared (IR) transceiver 266, a Bluetooth™ (BT) transceiver 268 operating using Bluetooth™ brand wireless technology developed by the Bluetooth™ Special Interest Group, a wireless universal serial bus (USB) transceiver 270 and/or the like. The Bluetooth™ transceiver 268 may be capable of operating according to low power or ultra-low power Bluetooth™ technology (for example, Wibree™) radio standards. In this regard, the wireless computing device 101 and, in particular, the short-range transceiver may be capable of transmitting data to and/or receiving data from electronic devices within a proximity of the wireless computing device 101, such as within 10 meters, for example. Although not shown, the wireless computing device 101 may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The wireless computing device 101 may comprise memory, such as a subscriber identity module (SIM) 238, a removable user identity module (R-UIM), and/or the like, which may store information elements related to a mobile subscriber. In addition to the SIM, the wireless computing device 101 may comprise other removable and/or fixed memory. The wireless computing device 101 may include volatile memory 240 and/or non-volatile memory 242. For example, volatile memory 240 may include Random Access Memory (RAM) including dynamic and/or static RAM, on-chip or off-chip cache memory, and/or the like. Non-volatile memory 242, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 240, non-volatile memory 242 may include a cache area for temporary storage of data. The memories may store one or more applications (e.g., software programs), instructions, pieces of information, data, and/or the like which may be used by the wireless computing device 101 for performing functions of the wireless computing device 101. For instance, as described in greater detail below, one or more of the memories on the device 101 may store a Marketplace application in various embodiments that performs various aspects of the claimed invention. In some embodiments, a wired computer device may be used to perform a variety of the functions herein associated with the wireless computing device. In various embodiments, a user may complete some functions related to the anonymous text and payment system on a wireless device and other functions related to the anonymous text and payment system on a wired device or different wireless device.

b. Exemplary Server

FIG. 3 provides a schematic of a server 104 residing in marketplace systems 105 according to one embodiment of the present invention. In general, the term “server” may refer to, for example, any computer, computing device, mobile phone, desktop, notebook or laptop, distributed system, server, blade, gateway, switch, processing device, or combination of processing devices adapted to perform the functions described herein. As will be understood from this figure, in one embodiment, the server 104 may include a processor 60 that communicates with other elements within the server 104 via a system interface or bus 61. The processor 60 may be embodied in a number of different ways. For example, the processor 60 may be embodied as one or more processing elements, one or more microprocessors with accompanying digital signal processors, one or more processors without an accompanying digital signal processors, one or more coprocessors, one or more multi-core processors, one or more controllers, and/or various other processing devices including integrated circuits such as, for example, an application specific integrated circuit (ASIC), a field programmable gate array (FPGA), a hardware accelerator, and/or the like.

In an exemplary embodiment, the processor 60 may be configured to execute instructions stored in the device memory or otherwise accessible to the processor 60. As such, whether configured by hardware or software methods, or by a combination thereof, the processor 60 may represent an entity capable of performing operations according to embodiments of the present invention when configured accordingly. A display device/input device 64 for receiving and displaying data may also be included in or associated with the server 104. The display device/input device 64 may be, for example, a keyboard or pointing device that is used in combination with a monitor. The server 104 may further include transitory and non-transitory memory, which may include both random access memory (RAM) 67 and read only memory (ROM) 65. The server's ROM 65 may be used to store a basic input/output system (BIOS) 26 containing the basic routines that help to transfer information to the different elements within the server 104.

In addition, in one embodiment, the server 104 may include at least one storage device 63, such as a hard disk drive, a CD drive, a DVD drive, and/or an optical disk drive for storing information on various computer-readable media. The storage device(s) 63 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. Additionally, each of these storage devices 63 may be connected to the system bus 61 by an appropriate interface.

Furthermore, a number of program applications (e.g., modules) may be stored by the various storage devices 63 and/or within RAM 67. Such program modules may include an operating system 80 and a data processing application 900. As discussed in greater detail below, this application 900 may control certain aspects of the operation of the server 104 with the assistance of the processor 60 and operating system 80, although its functionality need not be modularized. In addition to the program applications, the server 104 may store and/or be in communication with one or more storage media 107.

Also located within and/or associated with the server 104, in one embodiment, is a network interface 74 for interfacing with various computing entities. This communication may be via the same or different wired or wireless networks (or a combination of wired and wireless networks), as discussed above. For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), and/or any other wired transmission protocol. Similarly, the server 104 may be configured to communicate via wireless external communication networks using any of a variety of protocols, such as 802.11, GPRS, UMTS, CDMA2000, WCDMA, TD-SCDMA, LTE, E-UTRAN, Wi-Fi, WiMAX, UWB, and/or any other wireless protocol.

It will be appreciated that one or more of the server's 104 components may be located remotely from other server 104 components. Furthermore, one or more of the components may be combined and additional components performing functions described herein may be included in the server 104.

### III. GENERAL OVERVIEW OF THE PROCESS

FIG. 4 provides an example context in which various embodiments of the present invention may be used. In such embodiments, the user may communicate with the marketplace system 105 via a wireless computing device 101 and also with an Anonymous Phone Number 300 from the mobile messaging service provider 102. The marketplace system 105 may communicate with the Payment Processor to establish buyer and seller credentials and to process payments. The marketplace system 105 may also communicate with the mobile messaging service provider 102 to assign an Anonymous Phone Number 300 from a pool of available phone numbers and to send, receive, and process text messages.

FIG. 5 illustrates the user registration process according to various embodiments of the present invention. In various embodiments, the user registration process is completed by the registration module 107. In various embodiments, the marketplace system 105 may request information and receive input from the user via the user wireless computer device 101 over a wired or wireless network 103. In various embodiments, information requested from a user may comprise: Name, credit card or debit card information, checking account information, address, phone number, email address, zip code, demographic information, birthdate, and/or information about what types of items the user is interested in buying and/or selling. In some embodiments, the marketplace system 105 may communicate information related to completing transactions to the payment processor 109 over a wired or wireless network 103.

FIG. 6 shows various processes that may be completed by the browse/search module 108, in various embodiments. A user wireless computer device 101 may communicate with the marketplace system 105 allowing a user to make use of the functions associated with the browse/search module 108 at step 402. The user may then indicate that they wish to list an item for sale at step 424. In various embodiments, the marketplace system 105 may check to make sure the user is registered with the appropriate credentials for selling an item at step 426. If the user does not have the appropriate credentials, the marketplace system 105 may request information from the user via the user wireless computer device 101 necessary for credentialing the user to be a seller at step 430. If the user does have the appropriate credentials to be a seller, the user may then be prompted to enter information related to the item the user would like to sell at step 428.

If, at step 404, a user indicates that they would like to buy an item, in various embodiments, the marketplace system 105 may check to ensure the user is registered with the appropriate credentials to buy an item, at step 406. If the user does not have the appropriate credentials to be a buyer, the marketplace system may request information from the user via the user wireless computer device 101 necessary for credentialing the user to be a buyer at step 410. If the user does have the appropriate credentials to be a buyer, the marketplace system 105 may initiate a text and payment session with seller of the item at step 408.

FIG. 7 illustrates the steps that occur during a text and payment session according to various embodiments. At step 412, the marketplace system 105 opens a text and payment session between the buyer and the seller of particular item. The marketplace system 105 may then send text message prompts to the buyer and seller regarding the sale and exchange of the item at step 414. At step 416, text messages from the buyer and seller are processed until either the sale is completed or canceled. Once the sale is completed or canceled, the text message and payment session between the buyer and the seller is closed, at step 418.

FIG. 8 illustrates some of the text message processing that occurs during step 416. At step 4161 the marketplace system 105 receives a text message from the buyer or seller and determines whether the text message comprises a command or a PIN. If not, the marketplace system 105 sends the text message to the other user (the seller or buyer) at step 4162. If the text message does comprise a command or a PIN, the process continues to step 4163 wherein the marketplace system 105 determines if the text message comprises a buy command. If so, the marketplace system 105 may send a text prompt to the buyer requesting the buyer's PIN number at step 4164. If the text message does not comprise a buy command, the process continues to step 4165, wherein the marketplace system 105 determines if the message comprises a user's PIN. If the text message does comprise the user's PIN, the marketplace system 105 may process the order payment via the text and payment module 106 and/or request that the payment processor 109 process the payment, at step 4166. If, at step 4165, it is determined that the text message does not comprise a PIN, other commands that may comprise the text message are processed at step 4168.

The attached appendix illustrates and explains various screens that may be displayed to a user via a user wireless device 101, according to various embodiments. The particular example illustrated relates to buying and selling tickets related to a sporting or entertainment event; however, it should be understood that a variety of items may be bought and sold via the marketplace system 105 without departing from the scope of the invention.

### IV. CONCLUSION

Many modifications and other embodiments of the invention set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for facilitating anonymous texts and payments, the method comprising:
receiving input indicating a user selection of an item associated with a seller and a price that a user is interested in buying;
receiving a first text message from the user comprising a buy command;
providing a prompt to the user to provide a passcode via a second text message;
receiving a third text message from the user comprising the passcode; and
facilitating payment by the user to the seller of an amount based at least in part on the price associated with the item.

2. The method of claim 1 further comprising:
receiving a fourth text message from the user comprising a message for the seller; and
providing the message to the seller via a fifth text message that does not include a phone number directly associated with the user.

3. The method of claim 1 further comprising:
receiving a sixth text message from the seller comprising a message for the user; and
providing the message to the user via a seventh text message that does not include a phone number directly associated with the seller.

4. The method of claim 1 further comprising, after receiving input indicating the user selection of the item and before providing a prompt to the user to provide the passcode, determining if the user has the appropriate credentials to buy the item.

5. The method of claim 4, wherein if it is determined that the user does not have the appropriate credentials to buy the item, providing a prompt to the user to provide payment mechanism information.

6. The method of claim 5, wherein the payment mechanism information comprises at least one of a credit card number, a bank account number and routing number, a debit card number, or a gift card number.

7. The method of claim 1, further comprising providing a payment confirmation to at least one of the user and the seller via an additional text message.

8. A system for facilitating anonymous texts and payments, the system comprising:
one or more memory storage areas containing information associated with at least one item for sale, the information comprising a seller and a price, and profile data associated with at least one of a seller and a user; and
one or more processors configured to:
receive an indication of a user selection of an item that a user is interested in buying;
receive a first text message from the user comprising a buy command;
provide a prompt to the user to provide a passcode via a second text message;
receive a third text message from the user comprising the passcode; and
facilitate payment by the user to the seller of an amount based at least in part on the price associated with the item.

9. The system of claim 8 wherein the one or more processors are further configured to:
receive a fourth text message from the user comprising a message for the seller; and
provide the message to the seller via a fifth text message that does not include a phone number directly associated with the user.

10. The system of claim 8 wherein the one or more processors are further configured to:
receive a sixth text message from the seller comprising a message for the user; and
provide the message to the user via a seventh text message that does not include a phone number directly associated with the seller.

11. The system of claim 8 wherein the one or more processors are further configured to:
after receiving the indication of the user selection of the item and before providing a prompt to the user to provide the passcode, determine if the user has the appropriate credentials to buy the item.

12. The system of claim 11, the one or more processors are further configured to, if it is determined that the user does not have the appropriate credentials to buy the item, provide a prompt to the user to provide payment mechanism information.

13. The method of claim 12, wherein the payment mechanism information comprises at least one of a credit card number, a bank account number and routing number, a debit card number, or a gift card number.

14. The system of claim 8, wherein the one or more processors are further configured to provide a payment confirmation to at least one of the user and the seller via another text message.

15. A computer program product for facilitating anonymous texts and payments, the computer program product comprising at least one non-transitory computer-readable storage medium having computer-readable program code portions embodied therein, the computer-readable program code portions comprising:
an executable portion configured for receiving a plurality of data, the plurality of data comprising:
information associated with at least one item for sale, the information comprising a seller and a price, and
profile data associated with at least one of a seller and a user; and
an executable portion configured for receiving an indication of a user selection of an item that a user is interested in buying;
an executable portion configured for receiving a first text message from the user comprising a buy command;
an executable portion configured for providing a prompt to the user to provide a passcode via a second text message;
an executable portion configured for receiving a third text message from the user comprising the passcode; and
an executable portion configured for facilitating payment by the user to the seller of an amount based at least in part on the price associated with the item.

16. The computer program product of claim 15 further comprising
an executable portion configured for receiving a fourth text message from the user comprising a message for the seller; and
an executable portion configured for providing the message to the seller via a fifth text message that does not include a phone number directly associated with the user.

17. The computer program product of claim 15 further comprising:
an executable portion configured for receiving a sixth text message from the seller comprising a message for the user; and
an executable portion configured for providing the message to the user via a seventh text message that does not include a phone number directly associated with the seller.

18. The computer program product of claim 15 further comprising:
an executable portion configured for, after receiving the indication of the user selection of the item and before providing a prompt to the user to provide the passcode, determining if the user has the appropriate credentials to buy the item.

19. The computer program product of claim 18, further comprising:
an executable portion configured for, if it is determined that the user does not have the appropriate credentials to buy the item, providing a prompt to the user to provide payment mechanism information.

20. The computer program product of claim 15, further comprising:
an executable portion configured for providing a payment confirmation to at least one of the user and the seller via another text message.
